(19) United States
(12) Patent Application Publication
(10) Pub. No.: US 2002/0137369 A1
(43) Pub. Date: Sep. 26, 2002

(54) Land grid array (LGA) module assembly that maximizes substrate area for electronic devices

(75) Inventors: David Linn Edwards, Poughkeepsie, NY (US); Michael Joseph Ellsworth JR., Lagrangeville, NY (US); John G. Torok, Poughkeepsie, NY (US); Hilton T. Toy, Wappingers Falls, NY (US); Jeffrey Allen Zitz, Poughkeepsie, NY (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 09/814,322

(22) Filed: Mar. 21, 2001

(51) Int. Cl. H01R 12/00

(52) U.S. Cl. 439/77

(57) ABSTRACT

The present invention relates generally to a new apparatus and method for a land grid array electronic module. The land grid array electronic module packaging assembly includes a substrate member upon which electronic components are mounted and which is permanently fastened to an frame member that engages an alignment and mounting feature of an underlying socket. The frame member is sized to overlap the substrate member on at least two opposing edges thereof, and is permanently affixed to the substrate member by an adhesive applied to the overlap. The assembly arrangement allows a permanently correct alignment of the substrate to the underlying socket at minimal expense in valuable substrate top surface real estate. The adhesive accommodates the different thermal expansions between the substrate member and frame member.

### BACKGROUND OF THE INVENTION

1. Field of the Invention

The present invention is generally directed to a mechanism for engaging electronic circuit modules having a land grid array (LGA) socket device, and to a method requiring minimal surface area to firmly attach the substrate member upon which components are mounted to a frame member which fastens the LGA into the underlying socket, even under varying thermal expansion conditions.

2. Description of the Related Art

The land grid array interconnection system is a popular means for mechanical and electrical interconnection between electronic circuit components and electronic cards. Conventional land grid array interconnection mechanisms suffer from certain disadvantages. In particular, these mechanisms require relatively large compressive forces to maintain sufficient electrical contact throughout the card/socket/module system. Typically a clamping mechanism is used in which a pressure plate fits over the top surface of the module assembly. This pressure plate is typically fastened to the electronic card via screws. The compressive force generated by such a mechanism can impart large tensile, compressive and shear stresses on sensitive electrical components such as the silicon chip, the substrate or chip carrier (usually ceramic), the chip underfill material, lid adhesive and any thermal compound which may be disposed between the chip and an overlying lid. The compressive mechanism can consume substantial amounts of “real estate” of the top surface of the chip carrier.

Additionally, the land grid array interconnection mechanism is usually targeted for leading edge, high performance modules that generate significant amounts of heat. Thus, thermal performance is important in the LGA interconnection mechanism design. The pressure plate typically comprises a structural material such as steel which is provided for its strength. The thermal conductivity of steel is significantly less than the thermal conductivity of such materials as aluminum or copper. The thermal rate of expansion of the ceramic substrate differs from that of the compression mechanism so that the overall assembly is subject to mechanical distortion as components expand differently under the generated heat.

FIG. 1 illustrates an isometric view of one version of a conventional LGA assembly, as described in commonly assigned U.S. Pat. No. 6,191,480 to Kastberg, et al. In this assembly, LGA socket 10 receives land grid array module 11 which includes semiconductor chip or die 12. Module 11 includes an upper surface which is exposed so as to be engageable with spring portions 13 of ring shaped pressure plate 14. Pressure plate 14 includes integral spring portions 13 which are urged against the top exposed portion of module 11 and is fastened to socket 10 by screw fasteners 15. Chip 12 or a heat spreader 21 (see FIG. 2) is accessible through open central portion of pressure plate 14. Integral spring portions 13 supply force to engage electrical contact between module 11 and land grid array socket 10. Pressure plate 14 therefore applies force directly to the chip carrier periphery rather than to the chip or to the chip lid. This eliminates mechanical stresses that might otherwise occur in critical module components such as the chip, chip underfill material or in adhesives. Compression of peripheral spring portions 13 provides a smooth, even engagement force while flattening at a full engagement position so as to allow the lid of a module to protrude through the opening. In this way, commercially available heat sinks such as that shown in FIG. 2 as reference numeral 20 may be employed. FIG. 2 also illustrates the inclusion of heat spreader 21.

FIG. 3 illustrates a side view of a second version of this conventional LGA assembly in which chip underfill material 31 is more readily visible. Support frame structure 32 (see also FIG. 4) surrounding module 11 includes hinge support members 33 through which arms 34 are disposed. Arm 34 is an L-shaped structure, as is apparent from the isometric view shown in FIG. 4, and includes pressure rail 35 affixed by spot welding to arm 34. Arms 34 and pressure rails 35 are provided on either side of module 11, which includes a top exposed lip portion against which pressure rails 35 may be urged by a pivoting operation of arms 34 which provide spring action for maintaining a constant pressure whenever the module is disposed in the socket and the arms 34 are locked into position. Notches 41 (FIG. 4) at the ends of the arms extending through hinge support members 33 provide a locking engagement. Arm 34 provides a smooth even engagement force which permits the lid of a module to protrude through the frame support so that commercially available heat sinks 20 are easily attachable to the apparatus.

Pressure plate 14 (FIGS. 1, 2) is comprised of a material such as spring steel. Additionally, pressure rail 35 (FIGS. 3, 4) are comprised of a material such as spring steel while arms 34 is comprised of a material such as stainless steel. Support frame 32 preferably is comprised of a material such as copper or aluminum.

Although this conventional LGA assembly provides a low profile and provides an LGA engagement mechanism which eliminates some stresses, reduces others and which provides easy attachment of heat sink devices, it has problems. The frame member is spring-loaded and is not permanently attached to the substrate member. As a consequence, the substrate is not accurately located relative to the frame. The different materials have different coefficients of thermal expansion, which causes mechanical stresses as the electronic device 12 heats up. Additionally, the frame takes up valuable real estate on the substrate. The clamping mechanism illustrated in FIG. 4 adds additional components which are themselves subject to failure and also consumes valuable real estate.

A third example of a conventional is illustrated in FIG. 10. This exploded top to bottom view shows heatsink 1001 in contact with a module 1003 (contains microprocessor or similar device) and inserted into socket frame 1004 and mounted on printed circuit card 1005. A thermal interface material such as thermal paste, oil, or a phase-change thermal pad is typically applied between heatsink 1001 and module 1003. Beneath printed circuit card 1005 is an insulator 1006 preventing shorts between exposed vias or other conductive elements and the backside stiffener 1007, typically metallic and conductive. Alternatively, a non-conductive coating could be applied to the backside stiffener 1007 to inhibit shorting. Posts 1002 on heatsink 1001 pass through the holes provided on the printed circuit board to hold the components in proper position. Load screw 1010 is installed into threaded insert 1009 press fitted into a hole in spring load plate 1008.

There are several disadvantages of a design having an LGA post 1002 on heatsink 1001. First, a large area is used due to lid 1003A on module 1003. Second, it causes additional interfaces between the chip and heatsink. Additionally, there is no direct cooling on individual devices.

### SUMMARY OF THE INVENTION

In view of the foregoing and other problems of the conventional methods and structures, it is an object of the present invention to provide a mechanism for ensuring electrical and mechanical contact between a land grid array module and its corresponding socket mounted on a board.

It is also an object of the present invention to provide a structure in which virtually all the top surface area is available for components rather than assembly attachment or clamping hardware.

It is also an object of the present invention to provide a module upon which various fragile and densely packed types of components such as flip chips, wire bonds, or ball grid array devices can be mounted.

It is also an object of the present invention to provide a semiconductor packaging mechanism which provides a land grid array module engagement mechanism for which removability of the land grid array module is readily available.

It is a still further object of the present invention to provide a semiconductor package and packaging mechanism with a heatsink interface for removing thermal energy from semiconductor chip. Advantageously, the heatsink is directly contacting the chip rather than contacting a lid as in many conventional designs.

It is a still further object of the present invention to provide a permanent mounting of heatsinks in a variety of configurations including multiple heatsinks and including on-center or off-center attachment of heatsinks.

It is a still further object of the present invention to provide a semiconductor packaging and engagement mechanism for which mechanical stresses have been reduced, particularly for electronic components and the chip carrier substrate.

It is also an object of the present invention to provide an LGA interconnection mechanism for producing sufficiently large compressive forces to maintain electrical contact throughout a card/socket/module assembly.

It is yet another object of the present invention to eliminate the utilization of pressure plate that fits over the top surface of the module assembly and clamping devices commonly employed in LGA engagement mechanisms.

It is still another object of the present invention to reduce tensile, compressive and shear stresses on sensitive semiconductor module components including silicon chips, chip underfill material, adhesives and thermal compounds found in semiconductor packaging systems.

It is another object of the present invention to reduce stresses in LGA packaging which tend to produce bulk material fractures and material creep.

It is another object of the present invention to provide an LGA packaging mechanism for high power electronic circuit chips and modules.

It is another object of the present invention to provide an LGA package that facilitates handling.

It is another object of the present invention to provide an LGA package that allows heatsinks to overhang the sides of the substrate.

Lastly, but not limited hereto, it is yet another object of the present invention to provide an LGA packaging loading mechanism that consumes a minimal amount of real estate on the substrate member.

In accordance with one embodiment of the present invention, a semiconductor packaging assembly includes a land grid array socket module comprising a substrate member upon which are mounted electronic components such as discrete components, ASICs or other chips. The lower surface of the substrate member includes an interface for a socket on a component board such as a computer mother board. This substrate member has an area so as to overlap slightly, on at least two of its edges, frame member with a corresponding area which contains the attachment hardware to allow the assembly to be mounted onto the underlying electronic card socket. Such an attachment mechanism might be as simple as holes through which mounting bolts, studs, or screws pass to fasten the module to the electronic card.

The frame member and substrate member are permanently attached together by an elastomeric adhesive so that the two members are permanently and correctly aligned for mounting to the electronic card. The physical characteristics of the adhesive allow the substrate member to remain firmly attached to the frame member even under their respective different thermal expansions.

In accordance with another embodiment of the present invention, heat sinks in various configurations are mounted atop the electronic components mounted on the substrate member.

In a first aspect of the present invention, a land grid array packaging assembly is disclosed having a substrate upon which electronic components are mounted and a frame member to engage an alignment and mounting feature of an underlying socket, wherein the frame member is sized to overlap the substrate on at least a section of at least two opposing edges, comers, or other surface areas such that, when the frame is engaged with the mounting feature, a combined engagement force vector using the overlap regions results in a vector substantially perpendicular to and substantially through the centerline of the underlying socket, and wherein the only areas of overlap between the frame member and the substrate are those areas of contact contributing to the combined engagement force vector.

In a second aspect of the present invention, an electronic packaging assembly is disclosed having a substrate upon which electronic components are mounted and a frame member to engage an alignment and mounting feature of an underlying socket, wherein the frame member is shaped to overlap the substrate on at least a section of at least two opposing edges of the substrate and only at these sections of opposing edges.

In a third aspect of the present invention, a method of affixing a substrate member to a frame member is disclosed in which the substrate member having a first coefficient of temperature expansion and having mounted thereon one or more electronic components, the frame member having a second coefficient of temperature expansion and having an attachment feature to allow the substrate member to be mounted to an underlying socket, the frame member sized to overlap the substrate member only in an area along predetermined sections of the peripheral edges of the substrate member. The method includes applying an elastomeric adhesive to at least some areas of the overlap, aligning the frame member and the substrate member based on the overlap, and clamping the frame member and the substrate member together until the adhesive forms a bond, wherein the elastomeric adhesive possesses properties that permit the substrate member and the frame member to remain bonded together as heat generated by the one or more electronic components causes the frame member and the substrate member to expand at different rates due to the two coefficients of temperature expansion.

In a fourth aspect of the present invention, a method of forming a land grid array packaging assembly is disclosed that includes mounting electronic components upon a substrate and forming a frame to engage an alignment and mounting feature of an underlying socket, the frame shaped to overlap the substrate on at least a section of at least two opposing edges of the substrate and only at these sections of edges.

In a fifth aspect of the present invention, a method of socketing a module is disclosed that includes forming a substrate upon which are mounted components, the substrate having an interface to an underlying socket, forming a frame to engage an alignment and mounting feature of the underlying socket, the frame sized to overlap by a predetermined amount a predetermined section of the periphery edge of the substrate such that, when the frame is engaged with the mounting feature, a combined engagement force vector using the overlap areas results in a vector substantially vertical to and substantially through the centerline of the underlying socket, and engaging the alignment and mounting feature to mount the substrate and frame such that the substrate socket interface engages the underlying socket.

In a sixth aspect of the present invention, a land grid array packaging assembly is disclosed that includes a substrate upon which electronic components are mounted and a frame member to engage an alignment and mounting feature of an underlying socket, wherein the frame member has an interior opening and is shaped to contact the substrate on a predetermined plurality of predetermined surface areas such that, when the frame is engaged with the mounting feature, a combined engagement force vector using these contact areas results in a vector substantially perpendicular to and substantially through the centerline of the underlying socket, and such that this predetermined plurality of surface areas is the only overlap between the substrate and the frame member.

In a seventh aspect of the present invention, a land grid array packaging assembly is disclosed that includes a substrate of a first size upon which at least one electronic component is mounted and a frame member of a second size larger than the first size and having an engagement mechanism to engage an alignment and mounting feature of an underlying socket, wherein the frame member has an opening in the center, at least one dimension of the opening being sized to provide a predetermined area of overlap with selected sections of the periphery edge of the substrate, and such predetermined area is the only overlap between the frame member and the substrate.

Thus, with the invention, a frame member and a substrate member are securely fastened together even as the two materials expand differently under use conditions. Additionally, with the invention, an LGA module is firmly fastened to an underlying socket using a minimum amount of top surface area of the substrate member.

### BRIEF DESCRIPTION OF THE DRAWINGS

The subject matter which is regarded as the invention is particularly pointed out and distinctly claimed in the concluding portion of the specification. The invention, however, both as to organization and method of practice, together with further objects and advantages thereof; may best be understood by reference to the following description taken in connection with the accompanying drawings in which:

FIG. 1 is an isometric view illustrating one embodiment of a conventional LGA assembly which employs a ring shaped pressure plate;

FIG. 2 is a view similar to FIG. 1 but additionally illustrating the inclusion of a heat sink device 20;

FIG. 3 is a side elevation view illustrating another conventional structure in which pressure is applied by a pair of pressure rails disposed on opposite sides of the LGA module;

FIG. 4 is an isometric view similar to FIG. 3 but better illustrating the positioning and operation of pressure rails and lever arms;

FIG. 5 is an isometric view showing a preferred embodiment of a structure 50 according to the present invention;

FIG. 6 shows a variation of a top and side view of a preferred embodiment of a structure 60 of the present invention;

FIG. 7 shows a possible variation of the bottom view of a preferred embodiment of a structure 70 of the present invention;

FIG. 8 shows a cross section of the embodiment illustrated by FIG. 5 to show a heatsink 56 mounted according to the present invention;

FIG. 9 shows a top and side view of another heatsink arrangement 90 according to the present invention; and

FIG. 10 shows a second example of a conventional mounting for a chip carrier, socket and heatsink onto printed circuit card.

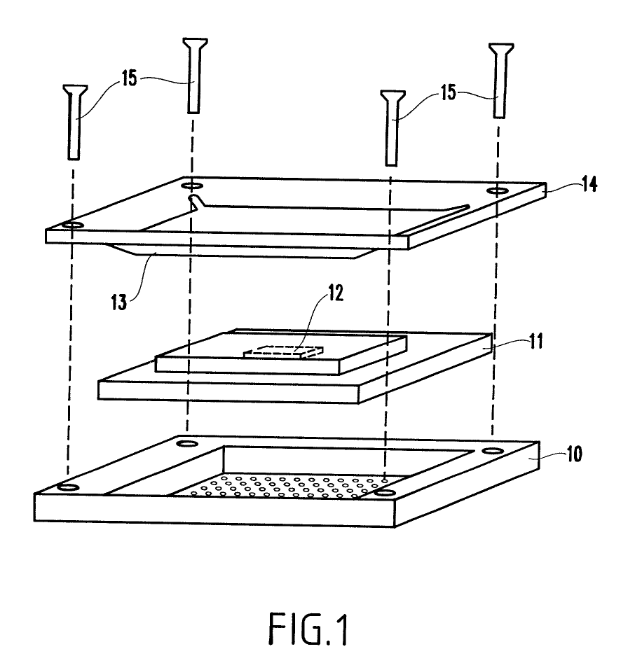

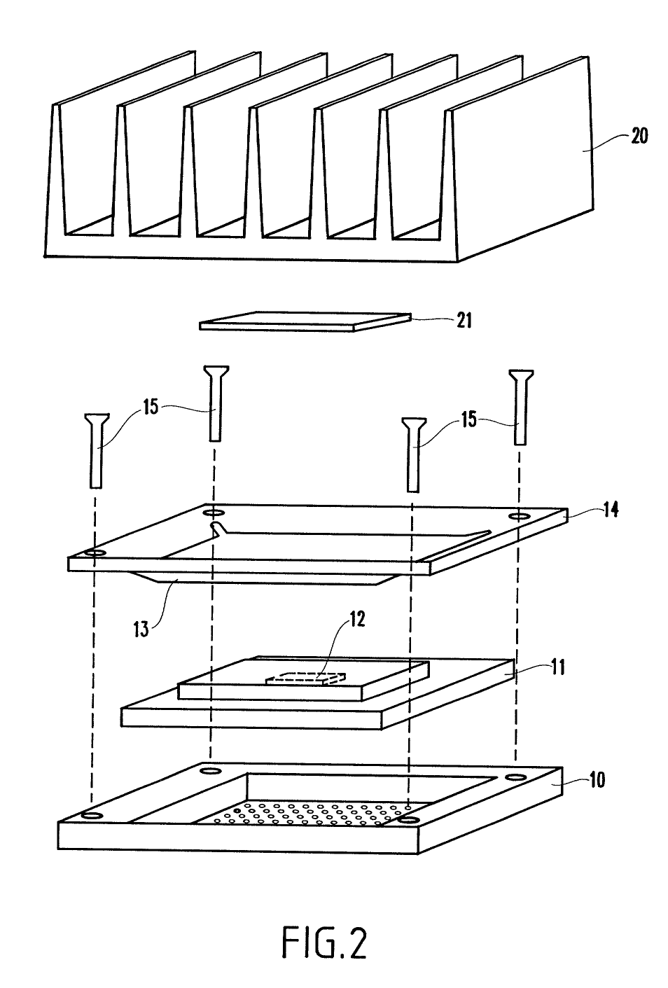

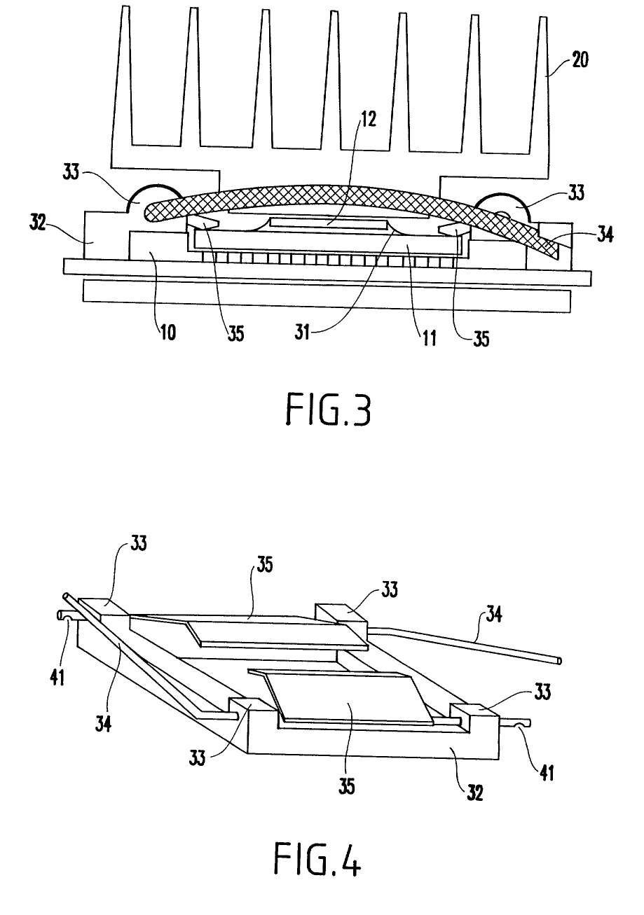

### DETAILED DESCRIPTION OF PREFERRED EMBODIMENTS OF THE INVENTION

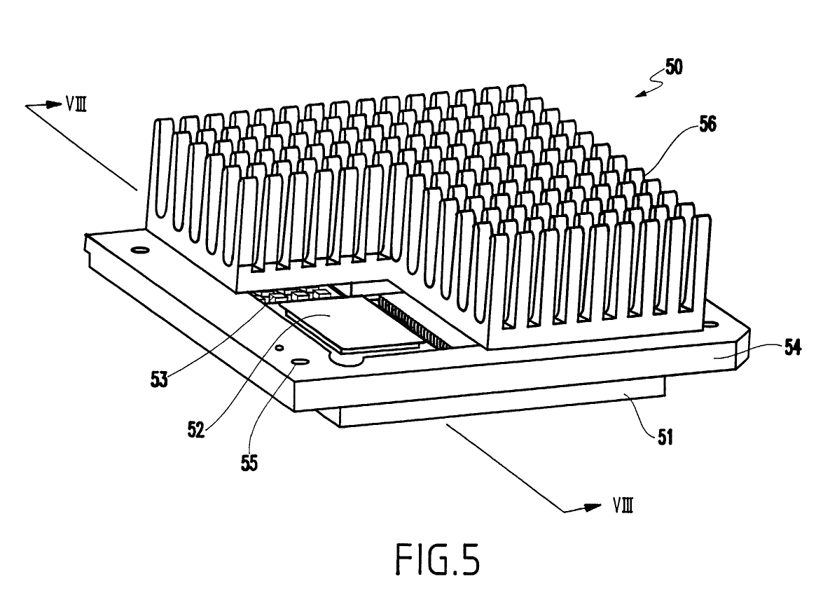

Referring now to FIG. 5 of the drawings, a preferred embodiment of a structure 50 according to the invention is illustrated. Structure 50 includes a substrate member 51, also referred to as a chip carrier since it serves the role of supporting electronic components such as electronic chips 52, ASICs, or discrete electronic components 53. Substrate member 51 includes an insulator, preferably ceramic (such as alumina, glass ceramic, mullite, ALN) or an organic (FR4, Polyimide, Teflon).

A frame member 54 sits astride substrate member 51 and serves to attach the assembly to an underlying electronic card (not shown). The underlying electronic card may include a socket to interface with the electronic chips 52 and passive components 53 contained on the substrate member 51, and the substrate member 51 typically has I/O pads for socket interface on its lower surface. As can be seen from this example, frame member 54 acts as an extension of the substrate member 51. The frame also serves as a mechanism to handle the module.

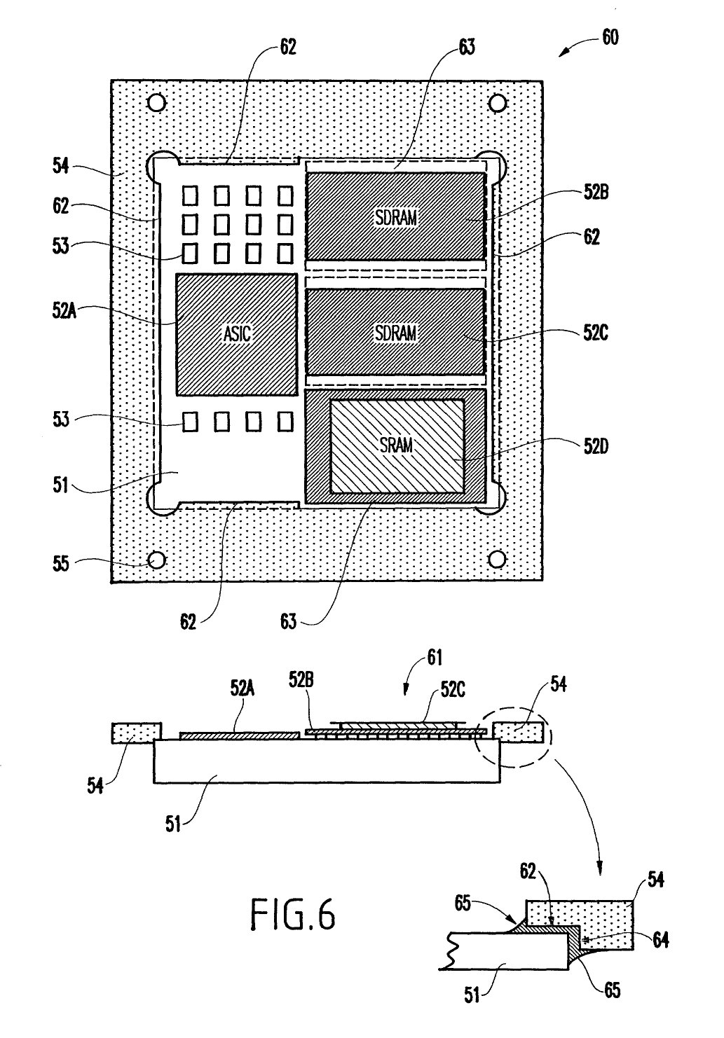

FIG. 6 shows a top view of a structure 60 and side view of the structure 60 (labeled with reference number 61 in the side view) of this preferred embodiment in an assembly stage before optional heatsinks 56 have been added. Substrate member 51 has a variety of chips 52A-52D mounted on its upper surface and passive components 53 such as discrete capacitors. Frame member 54 forms a peripheral frame around substrate member 51 and includes mounting features to allow the frame/substrate assembly to be mounted to the underlying electronic card. In this embodiment, the mounting feature is a series of four holes 55 arranged around the frame and through which would pass mounting studs, bolts, or screws. A key advantage of the invention is that it avoids the stress to components 52A-52D that is caused when heatsinks having LGA posts attached thereto are used for the LGA card attachment and engagement pressure is applied through the components.

The frame 54 and substrate 51 slightly overlap at the peripheral edges 62 of opposing edges of the frame opening. A key advantage of the invention is that the width of the overlap is very minimal (typically on the order of about 0.5 mm) compared to the overlap of the conventional design (typically 4 mm or more), thereby correspondingly reducing the amount of valuable substrate real estate consumed. The depth overlap is a key aspect to be considered for design of the substrate member and frame member, as further described below to be bonded together with an adhesive. The frame and substrate members are reliably attached if they can withstand approximately 75 psi of load.

Also as shown in this preferred embodiment, this overlap need not be along the entire edge since, as shown here, sections of the edge 63 may be shaped to accommodate the various chip sizes mounted on the substrate. There is considerable latitude on how much of the periphery edge is devoted to the overlap sections, the preferred method being that the overlap should be designed on opposing edges so that the frame as mounted to the underlying electronic card clamps down uniformly on the substrate. In some configurations, it would be sufficient to have the overlap on only two opposing edges, rather than on all four edges, as illustrated in FIG. 6. Generally, the more edges overlapping the better as this provides a better, more reliable connection. The frame needs to be properly supported on the substrate with an engagement force vector that is applied through the LGA socket connector vertical centerline.

Another feature of the illustrated embodiment is the use of an edge notch 64 along the overlap regions, in order to provide a more positive contact and alignment between the substrate and frame members.

A key feature of the invention is an elastomeric adhesive 65 applied to the overlap regions so that the substrate and frame members are permanently attached together. A preferred adhesive is sold by Dow Coming, Inc., under the trademark SYLGARD 577 ®, which is a two part polysiloxane base adhesive made by reacting polydimethyl siloxane, polysiloxane and silane in the presence of a catalyst. The elastomeric character of the adhesive 65 additionally allows the frame (typically, steel) and the ceramic substrate to be reliably bonded together even though the two materials have different thermal coefficients of expansion.

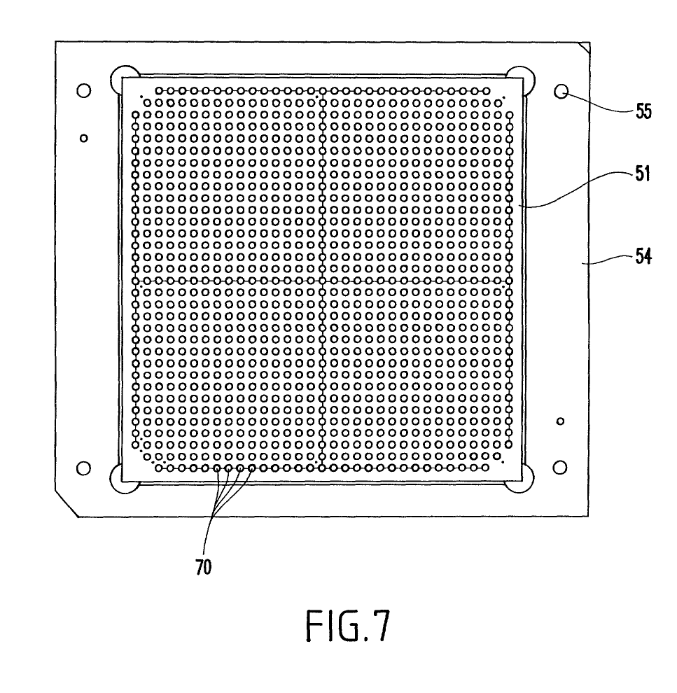

FIG. 7 illustrates a modified version of the bottom view of a preferred embodiment and shows substrate 51 surrounded by frame 54 containing mounting holes 55. In this example, the bottom surface of substrate 51 comprises a plurality of plated (gold) I/O pads 70 to form a contact array to interface electrically with a corresponding socket interface on the electronic card upon which the substrate/frame assembly is to be mounted. Other types of interfaces with the underlying electronic card would be obvious to one skilled in the art, after considering the present application as a whole.

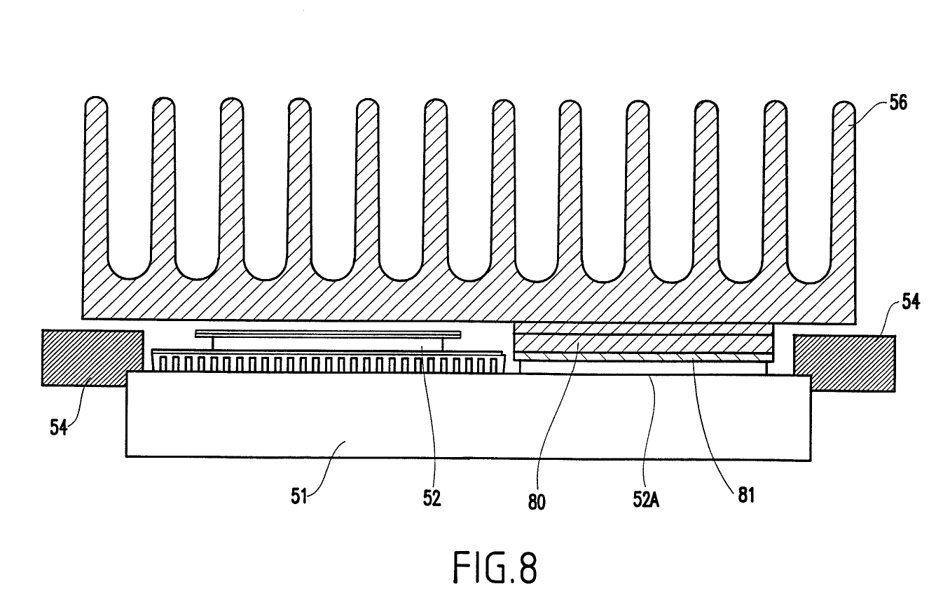

FIG. 8 is a cross section view of the configuration shown in FIG. 5 and illustrates a variation of a preferred embodiment in which heatsink 56 has been mounted to cover a portion of the assembly. In this example, the heatsink has been designed with a cut out so as not to cover electronic chip 52. A pedestal 80 of heatsink 56 contacts one or more predetermined components 52A, using an elastomeric heatsink interface 81 such as Sylgard 577 ® mentioned above. Additional examples of heatsink attach materials would be an epoxy sold by Al Technologies under trademark EG7655 Epoxy® and an adhesive sold by Chromerics, Inc., under the trademark T405 Pressure Sensitive Adhesive®. Heatsink 56 in this example is an off-center design to accommodate the location of the component requiring cooling, but any variation of heatsink design is possible and well known in the art.

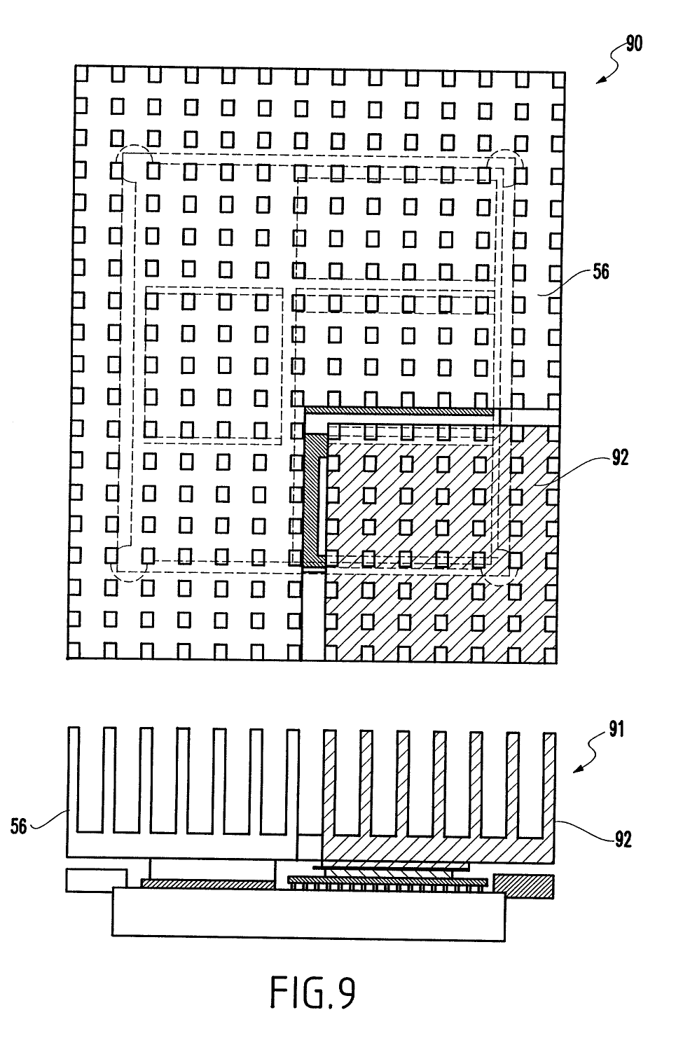

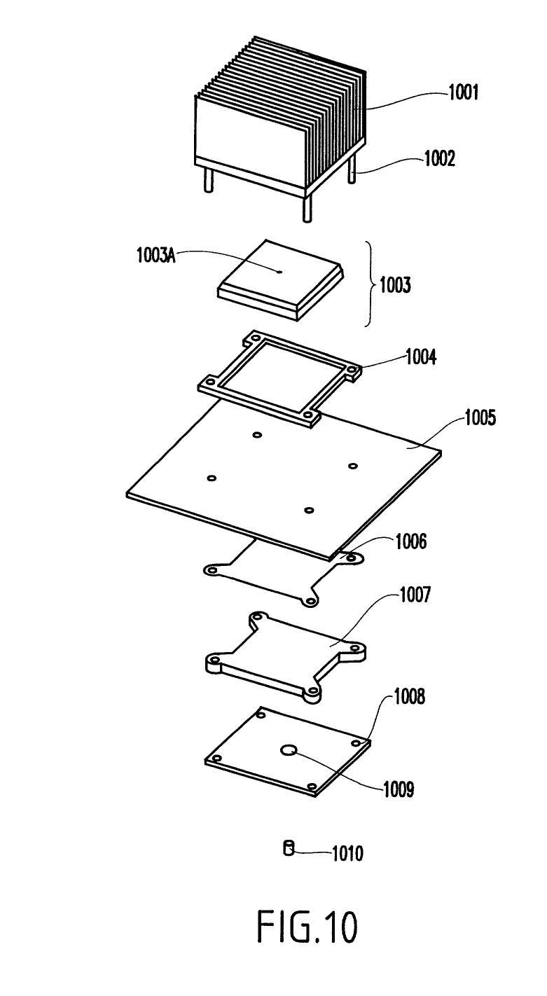

A top view of a structure 90 and a side view 91 of the same structure in FIG. 9 illustrate, for example, a variation in which a second heatsink 92 has been mounted in addition to heatsink 56, and demonstrates that multiple heatsinks could be mounted to accommodate almost any variation of component combinations. Details of the heatsink interface such as sizes and shapes would vary considerably but would be obvious to one of ordinary skill in the art within the purview of the present application.

While the invention has been described in terms of preferred embodiments, those skilled in the art will recognize that the invention can be practiced with modification within the spirit and scope of the appended claims.

The invention claimed is:

1. A land grid array packaging assembly comprising:
a substrate upon which electronic components are mounted; and
a frame member to engage an alignment and mounting feature of an underlying socket, said underlying socket electrically engaging an electronic circuit comprising said electronic components,
wherein said frame member is sized to overlap said substrate on at least a section of at least two opposing edges, comers, or other surface areas such that, when said frame is engaged with said mounting feature, a combined engagement force vector using said overlap regions results in a vector substantially perpendicular to and substantially through the centerline of said underlying socket, and wherein the only areas of overlap between said frame member and said substrate are those areas of contact contributing to said combined engagement force vector.

2. The land grid array packaging assembly of claim 1, wherein said frame member is affixed to said substrate by an adhesive applied to at least a portion of said overlap.

3. The land grid array packaging assembly of claim 2, wherein said adhesive comprises an elastomeric adhesive.

4. The land grid array packaging assembly of claim 1, wherein said substrate has an electrical interface on a bottom surface to engage said underlying socket.

5. The land grid array packaging assembly of claim 1, wherein said frame member is mounted on a surface of said substrate.

6. The land grid array packaging assembly of claim 1, wherein the substrate comprises a ceramic material.

7. The land grid array packaging assembly of claim 3, wherein said adhesive comprises Sylgard 577®.

8. The land grid array packaging assembly of claim 1, wherein at least one of said frame member and said substrate further comprises at least one notch along at least a portion of said overlap section of said at least two edges, comers, or other surface areas, said at least one notch serving to provide a positive alignment and engagement surface between said substrate and said frame member.

9. The land grid array packaging assembly of claim 1, wherein said frame member further comprises a shape permitting one or more heatsinks to be affixed to one or more of said electronic components mounted on said substrate, said one or more heatsinks protruding through an opening of said frame member.

10. An electronic packaging assembly comprising:
a substrate upon which electronic components are mounted; and
a frame member to engage an alignment and mounting feature of an underlying socket, wherein said frame member is shaped to overlap said substrate on at least a section of at least two opposing edges of said substrate and only at said sections of opposing edges.

11. The electronic packaging assembly of claim 10, wherein said frame member is affixed to said substrate member by an elastomeric adhesive applied to at least a portion of said overlap.

12. A method of affixing a substrate member to a frame member, said substrate member having a first coefficient of temperature expansion and having mounted thereon one or more electronic components, said frame member having a second coefficient of temperature expansion and having an attachment feature to allow said substrate member to be mounted to an underlying socket, said frame member sized to overlap said substrate member only in an area along predetermined sections of the peripheral edges of said substrate member, said method comprising: applying an elastomeric adhesive to at least some areas of said overlap;
aligning said frame member and said substrate member based on said overlap; and
clamping said frame member and said substrate member together until said adhesive forms a bond, wherein
said elastomeric adhesive possesses properties that permit said substrate member and said frame member to remain bonded together as heat generated by said one or more electronic components causes said frame member and said substrate member to expand at different rates due to said two coefficients of temperature expansion.

13. A method of forming a land grid array packaging assembly comprising:
mounting electronic components upon a substrate; and
forming a frame to engage an alignment and mounting feature of an underlying socket, said frame shaped to overlap said substrate on at least a section of at least two opposing edges of said substrate and only at said sections of edges.

14. The method of claim 13, further comprising:
affixing said frame to said substrate by an adhesive applied to at least some areas of said overlap.

15. The method of claim 13, further comprising:
mounting one or more heat sinks directly to said electronic components mounted on said substrate such that said one or more heat sinks protrude through an opening in said frame.

16. A method of socketing a module, comprising:
forming a substrate upon which are mounted components, said substrate having an interface to an underlying socket;
forming a frame to engage an alignment and mounting feature of said underlying socket, said frame sized to overlap by a predetermined amount a predetermined section of the periphery edge of said substrate such that, when said frame is engaged with said mounting feature, a combined engagement force vector using said overlap areas results in a vector substantially vertical to and substantially through the centerline of said underlying socket; and
engaging said alignment and mounting feature to mount said substrate and frame such that said substrate socket interface engages said underlying socket.

17. The method of claim 16, wherein said frame member is affixed to said substrate by an adhesive applied to at least some areas of said overlap.

18. The method of claim 17, wherein said adhesive comprises an elastomeric adhesive.

19. The method of claim 16, wherein said substrate has an electrical interface on the bottom surface thereof to engage said underlying socket.

20. The method of claim 16, wherein said frame member is mounted on a top surface of said substrate.

21. The method of claim 16, wherein the substrate comprises a ceramic material.

22. The method of claim 17, wherein the adhesive comprises Sylgard 577® .

23. The method of claim 16, wherein either said frame member or said substrate further comprises at least one notch along said overlap section of said at least two edges, said at least one notch serving to provide a positive alignment of said substrate engaging with said frame member.

24. The method of claim 16, wherein said frame member further comprises a shape having a central opening permitting one or more heatsinks to be affixed to one or more of said electronic components mounted on said substrate, said one or more heatsinks protruding through said central opening of said frame member.

25. A land grid array packaging assembly comprising:
a substrate upon which electronic components are mounted; and
a frame member to engage an alignment and mounting feature of an underlying socket,
wherein said frame member has an interior opening and is shaped to contact said substrate on a predetermined plurality of predetermined surface areas such that, when said frame is engaged with said mounting feature, a combined engagement force vector using said contact areas results in a vector substantially perpendicular to and substantially through the centerline of said underlying socket, and such that said predetermined plurality of surface areas is the only overlap between said substrate and said frame member.

26. The land grid array packaging assembly of claim 25, wherein
said frame member is affixed to said substrate by an adhesive applied to one or more of said contact areas.

27. The land grid array packaging assembly of claim 25, wherein
said said opening in said frame member is shaped to permit at least one heat sink to be affixed to at least one of said electronic components and an upper portion of said at least one heat sink protrudes through said opening.

28. The land grid array packaging assembly of claim 25, further comprising at least one notch in at least one of said frame member and said substrate, such that said one or more notches serves to align said frame member and said substrate.

29. A land grid array packaging assembly comprising:
a substrate of a first size upon which at least one electronic component is mounted; and
a frame member of a second size larger than said first size having an engagement mechanism to engage an alignment and mounting feature of an underlying socket, wherein
said frame member has an opening in the center, at least one dimension of said opening being sized to provide a predetermined area of overlap with selected sections of the periphery edge of said substrate, and such predetermined area is the only overlap between said frame member and said substrate.

30. The land grid array packaging assembly of claim 29, wherein
said frame member is affixed to said substrate by an adhesive applied to selected portions of said overlap.

31. The land grid array packaging assembly of claim 29, wherein
said selected sections of said overlap are selected such that, when said frame is engaged with said mounting feature, a combined engagement force vector using said overlap areas results in a vector substantially perpendicular to and substantially through the centerline of said underlying socket.
